(19) United States
(12) Patent Application Publication
(10) Pub. No.: US 2013/0327593 A1
(43) Pub. Date: Dec. 12, 2013

(54) STEP LADDER

(71) Applicant: Anthony Perkins, Cottonwood Heights, UT (US)

(72) Inventor: Anthony Perkins, Cottonwood Heights, UT (US)

(21) Appl. No.: 13/901,076

(22) Filed: May 23, 2013

Related U.S. Application Data
(60) Provisional application No. 61/651,055, filed on May 24, 2012.

(51) Int. Cl. E06C 1/14

(52) U.S. Cl. CPC E06C 1/14
USPC 182/180.1

(57) ABSTRACT

A double-sided step ladder is provided comprising a first frame having a plurality of spaced apart steps and a second frame having a plurality of spaced apart steps. The plurality of steps on the first frame includes a bottom step located at a first height relative to the base of the ladder with each successive step being spaced apart along the frame at various heights relative to the bottom step of the first frame. The plurality of steps on the second frame also includes a bottom step, the bottom step of the second frame being located at a second height relative to the base of the ladder with each successive step being spaced apart along the frame at various heights relative to the bottom step of the second ladder. The plurality of steps on the first frame and the second frame are located such that the heights of the plurality of steps on the first frame are staggered relative to the heights of the plurality of steps on the second frame.

### THE FIELD OF THE INVENTION

The present invention relates to ladders. More specifically, the present invention is related to an improved double-sided step ladder having steps with staggered spacing relative to each side of the step ladder and which may be of particular use to craftsmen and workmen in general.

### BACKGROUND

Step ladders are free-standing ladders that can be erected without support from a wall, and can be folded together under transport. A step ladder may consist of a frame with steps, or step frame, which is pivotally attached to a smaller support frame. Step ladders constructed in this manner are commonly called single-sided step ladder. A double-sided step ladder (also called a two-sided or twin ladder) may also consist of two frames pivotably attached to each other, however, both frames include steps.

Double-sided step ladders currently available on the market vary in height, typically ranging from 4 ft. to 20 ft., and include a plurality of evenly spaced steps. The steps are typically spaced about 1 ft. apart with the first step being about 1 ft. above the base of the ladder. Thus, for example, a 6 ft. double-sided step ladder will usually include 5 steps per side with an upper step common to both sides. Similarly, an 8 ft. ladder will have 7 steps per side with a common upper step.

In addition to being pivotably attached adjacent the upper step, the two frames of the double-sided step ladder are connected by a locking mechanism that prevents the step ladder from collapsing. Additionally, a small tray, sometimes called a utility tray, may be fastened to the ladder for holding tools, parts, paint etc., a feature that allows a workman to avoid time-consuming climbing up and down of the ladder.

The opposing steps on the two pivotably attached frames of a double-sided step ladder are generally parallel to each other. In other words, the first steps on the two pivotably attached frames will both be about 1 ft. above the base of the ladder with each successive step being spaced apart an additional 1 ft. up both frames. Thus, a double-sided step ladder can be ascended from either side to provide access to an elevated work site.

Often the elevated work site being accessed by a workman using a double-sided ladder is at a height that makes it uncomfortable for the workman to perform a task. Because the steps are spaced at about 1 ft. apart, the workman may have to choose to stand on a step which is slightly too low, thus causing the workman to stretch his or her body to reach the work site. The only alternative may be to stand on the next highest step, which may be slightly too high, causing the workmen to perform tasks in a crouched position. Either choice makes it more difficult for a workman to perform a task at the elevated work site, especially for an extended period of time. Additionally, the workman may fatigue more rapidly working in an extended or crouched position, thus making it more likely that he or she will have an accident while performing a task at the elevated work site.

In recent years telescopic and adjustable ladders have come to market. However, telescopic and adjustable ladders typically have complicated adjustment mechanisms and include a large number working components to function properly. This may cause these types of ladders to feel unstable and/or cause these types of ladders to be relatively heavy and more expensive as compared to a typical double-sided step ladder. Furthermore, use of telescopic and adjustable ladders may increase the time it takes to perform a task at an elevated work site because of the necessity to make the proper height adjustment. The adjustment mechanisms of telescopic and adjustable ladders may also become easily jammed by paint, glue, sand, concrete, etc. that is spilled in the mechanism. Thus, a workman may be further delayed trying to repair the ladder prior to safely using the telescopic or adjustable ladder. In comparison, a step ladder, such as a double-sided step ladder, can be easily and quickly erected due to their uncomplicated locking mechanism.

There is thus a need for an improved double-sided step ladder which can be used for extended periods of time at an elevated work site in safer and better ergonomic conditions.

### SUMMARY OF THE INVENTION

It is an object of the present invention to provide an improved double-sided step ladder.

According to one aspect of the invention a double-sided step ladder may include a first frame and a second frame each having a plurality of spaced apart steps. The first frame may include a bottom step located at a first height relative to the base of the ladder with each successive step being spaced apart along the frame at various heights relative to the bottom step of the first frame. The second frame may also include a bottom step, the bottom step of the second frame being located at a second height relative to the base of the ladder with each successive step being spaced apart along the frame at various heights relative to the bottom step of the second frame. The plurality of steps on the first frame and the second frame may be located such that the heights of the plurality of steps on the first frame are staggered relative to the heights of the plurality of steps on the second frame.

According to another aspect of the invention, the plurality of steps on at least one of the first frame and the second frame are located in evenly spaced apart increments.

According to another aspect of the invention, the plurality of steps on both the first frame and the second frame are located in evenly spaced apart increments so that the steps on the first frames are evenly staggered relative to the steps on the second frame.

According to another aspect of the invention, the bottom step of the first frame may be located at about 6 inches from the base of the ladder with each successive step being spaced apart in 1 ft. increments along the first frame relative to the bottom step of the first frame. The bottom step of the second frame may be located at about 1 ft. from the base of the ladder with each successive step being spaced apart in about 1 ft. increments relative to bottom step of the second frame.

According to another aspect of the invention, a support plate may be attached to at least one of the first frame and the second frame.

These and other aspects of the present invention are realized in an improved double-sided step ladder as shown and described in the following figures and related description.

### BRIEF DESCRIPTION OF THE DRAWINGS

Various embodiments of the present invention are shown and described in reference to the numbered drawings wherein:

FIG. 1 shows a front, perspective view of a double-sided step ladder according to principles of the present invention;

FIG. 2 shows a side, perspective view of the double-sided step ladder of FIG. 1;

FIG. 3 shows a front view of the double-sided step ladder of FIG. 1; and

FIG. 4 shows a side, cross-sectional view along plane 1-1 of the double-sided step ladder shown in FIG. 3.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

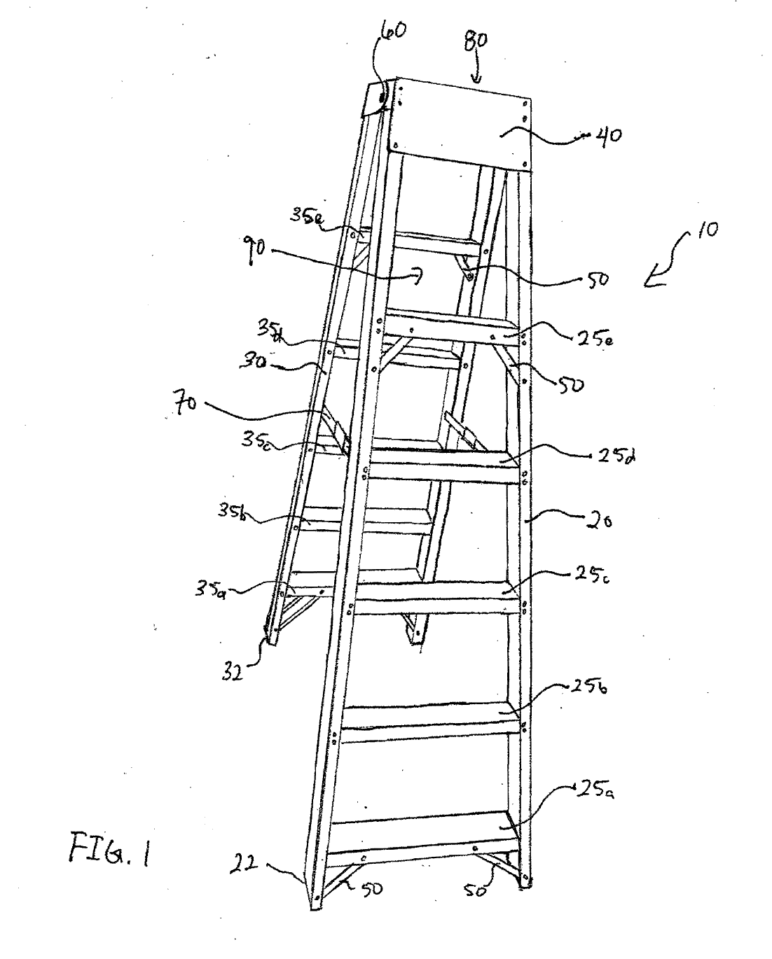

Turning now to FIG. 1, a perspective view of front, perspective view of a double-sided step ladder, generally indicated at 10, according to principles of the present invention. A first frame 20 may be attached to a second frame 30 so as to form the double-sided step ladder 10. For example, the first frame 20 may be pivotably attached to the second frame 30 at pivot point 60 which allows the bottom end 22 and the bottom end 32 of the first frame 20 and the second frame 30, respectively, to move outwardly and away from each other. The double-sided step ladder 10 may also include one or more locking mechanisms 70 which secures the ladder in an inverted V shape when the bottom ends 22, 32 are extended sufficiently away from each other. Thus, the double-sided step ladder 10 may be easily and quickly erected.

The first frame 20 may include a plurality of spaced apart steps 25a-e located at various heights along the first frame 20. The bottom step 25a may be attached to the first frame 20 at a first height relative to the base of the ladder 10 (e.g. the bottom ends 22, 32 of the first and second frame 20, 30, respectively). For example, the bottom step 25a may be attached to the first frame 20 so that it is about 1-12 inches above the base of the ladder 10. Each additional step 25b-e may be attached to the first frame 20 at various heights relative to the bottom step 25a. For example, step 25b may be about 1 ft. above bottom step 25a and step 25c may be about 1 ft. above step 25b, etc.

Similarly, the second frame 30 may include a plurality of spaced apart steps 35a-e located at various heights along the second frame 30. The bottom step 35a may be attached to the second frame 30 at a second height relative to the base of the ladder 10. According to principles of the present invention, the second height of the bottom step 35a of second frame 30 is different than the first height of the bottom step 25a of the first frame 20. However, the bottom step 35a may be attached to the first frame 20 so that it is about 1-12 inches above the base of the ladder 10 so long the height of the two bottom steps 25a, 35a differ relative to the base of the ladder. Similar as discussed above, each additional step 35b-e may be attached to the second frame 30 at various heights in evenly spaced increments relative to the bottom step 35a.

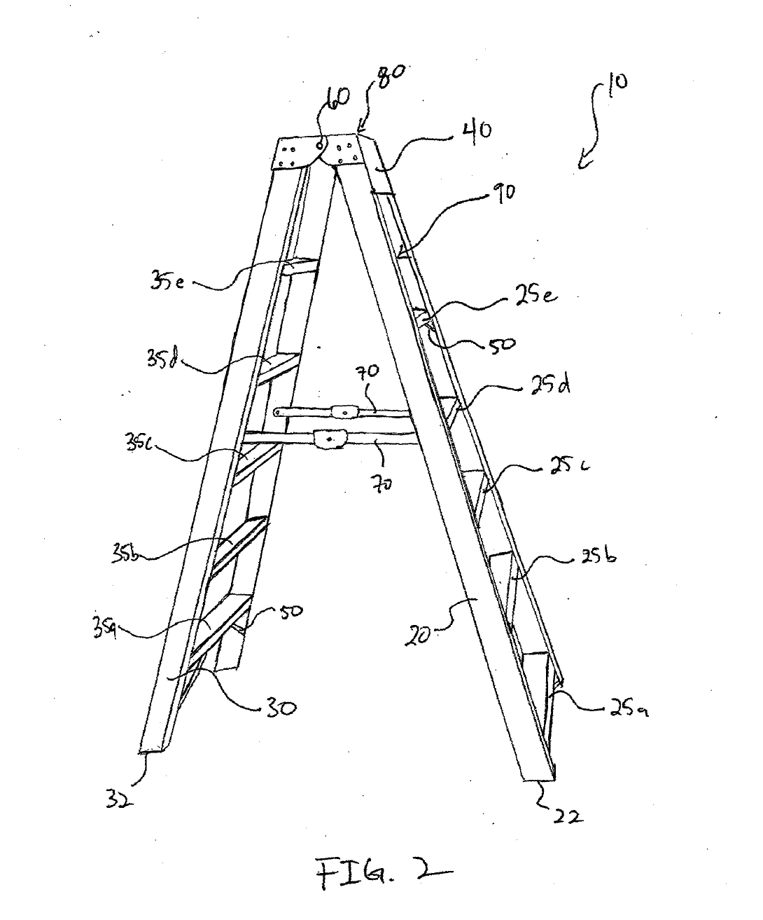

As is more clearly shown in FIG. 2, the plurality of steps 25a-e and the plurality of steps 35a-e may be attached to their respective frames 20, 30 such that the heights of the plurality of steps 25a-e on the first frame 20 are staggered relative to the heights of the plurality of steps 35a-e on the second frame 30. Thus, a workman using a double-sided ladder of the present invention may ascend the ladder 10 from one side to access an elevated work site. If, however, it is uncomfortable to perform a task at the elevated work site because the site is either too close or too far away, then the workman can ascend the opposite side of the ladder 10, which has steps at different heights, so that work can be performed under better ergonomic conditions.

Furthermore, performing work at an elevated work site from a position that is comfortable to the workman may improve safety as the workman may not have to stretch or crouch to perform a task. Stretching or crouching while working may make it more difficult for the workman to maintain his or her balance on a prior art double-sided step ladder and/or cause the workman to become fatigued quicker. This may be especially true if the workman must have to perform a task(s) at the elevated work site for an extended period of time.

It will be appreciated that the plurality of steps 25a-e attached to the first frame 20 may be substantially evenly spaced and/or the plurality of steps 35a-e may be substantially evenly spaced, however, such is not required by the principles of the present invention. A ladder 10 of the present invention may have unevenly spaced steps on one or both side that are configured to provide a plurality of good ergonomic conditions for working at a particular elevated site. For example, a particular elevated work site may cover a substantial area. Working in one section of the elevated work site may be more comfortable when standing on a step located on the first side of the ladder 10, while a task may be more comfortably performed in another section of the area from a different height. To access this other section the workman may only need to climb down the first side and ascend the opposite side. In contrast, if a telescopic or adjustable ladder was being used, the workman would have to adjust the ladder each time he or she needed to access different sections of the elevated work site. This may substantially slow down the progress of the work that needs to be performed and/or cause the workman to attempt tasks in different sections of the work site by dangerously stretching or crouching to reach a particular section of the worksite.

Also shown in FIGS. 1 and 2 is support plate 40. Although not necessary, the double-sided ladder of the present invention may be safer and more stable if a support plate 40 is attached to the first frame 20 adjacent the top 80 of ladder 10. Because the upper most step 25e is attached to the first frame 20 at a location that is lower relative to the top 80 than what would be expected in a conventional double-sided step ladder, this may create a substantial void 90 between the upper step 25e and the top 80 of ladder 10. The support plate 40 may extend below the top 80 of ladder 10 so as to lessen the size of the void 90 so that it decreases the possibility that a workman may fall through the void 90. Also, support plate 40 may increase the overall stability of the ladder 10. Additionally, one or more of the plurality of steps 25a-e and 35a-e may include a support member 50 to reinforce one or more of the plurality of steps.

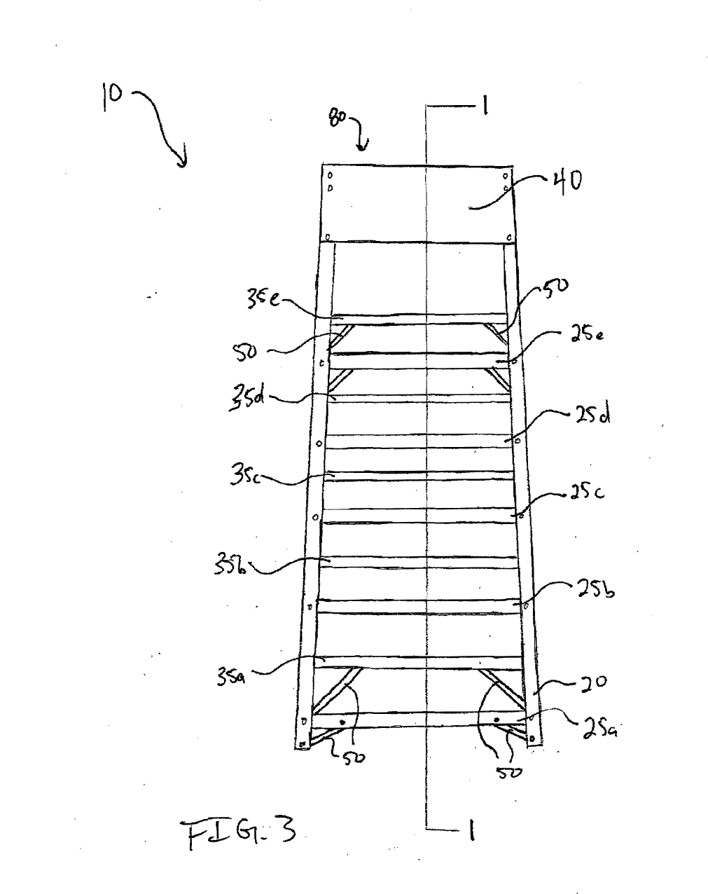

Turning now to FIG. 3, a front view of the double-sided step ladder 10 of FIG. 1 is shown. As can be clearly seen in FIG. 3, the plurality of steps 25a-e attached to the first frame 20 are located at various heights and the plurality of steps 35a-e attached to the second frame (not shown) are located at different various height which are offset or staggered relative to the heights of steps 25a-e. Thus, a workman will have at least twice the number of steps located at different heights relative to the base of the ladder in which he or she may stand when working at an elevated work site as compared to similarly sized conventional double-sided step ladder. It will be appreciated that the double-sided step ladders 10 according to principles of the present invention (like conventional double-sided step ladders) may have an overall length that ranges from 4 ft. or less to 20 ft. or more and that more or less steps may be attached to the first frame and second frame depending on the overall length of the ladder 10.

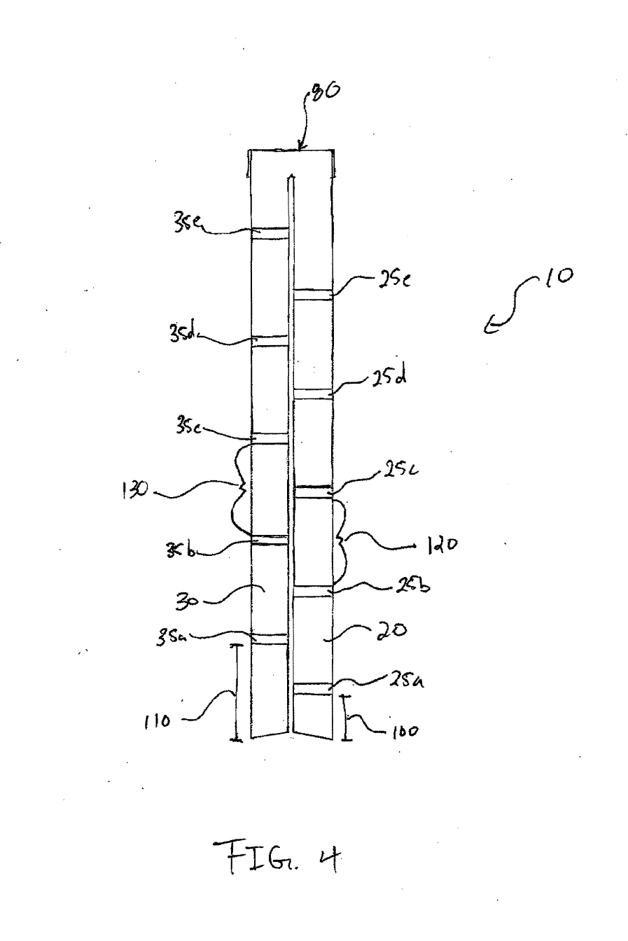

Referring now to FIG. 4, there is shown a side, cross-sectional view along plane 1-1 of the double-sided step ladder shown in FIG. 3. The bottom step 25a of the first frame 20 may be located a first distance 100 (e.g. about 6 inches) from the base of the ladder 10 with each successive step 25b-e being spaced apart in 1 ft. increments 120 along the first frame 20 relative to the bottom step 25a. The bottom step 35a of the second frame 30 may be located at second distance 110 (e.g. about 1 ft.) from the base of the ladder with each successive step 35b-e being spaced apart in about 1 ft. increments 130 relative to bottom step 35a.

It will be appreciated that the plurality of steps 25a-e attached to the first frame 20 may be substantially evenly spaced and/or the plurality of steps 35a-e may be substantially evenly spaced. As explained above, however, an uneven staggering of steps 25a-e relative to steps 35a-e may be preferred in some circumstances.

There is thus disclosed an improved double-sided step ladder. It will be appreciated that numerous changes may be made to the present invention without departing from the scope of the claims.

What is claimed is:

1. A double-sided step ladder comprising:
a first frame having a bottom step;
a second frame having a bottom step, wherein the second frame is attached to the first frame so as to form an inverted V shaped ladder having a base;
wherein the at least one step of the first frame is attached to the first frame at a first height relative to the base of the ladder and the at least on step of the second frame is attached to the second frame at a second height relative to the base of the ladder; and
wherein the first height is different than the second height.

2. The double-sided step ladder of claim 1, further comprising a plurality of steps attached to the first frame and a plurality of steps attached to the second frame.

3. The double sided step ladder of claim 2, wherein the plurality of steps attached to the first frame are evenly spaced apart from bottom step.

4. The double-sided step ladder of claim 2, wherein the plurality of steps attached to the first frame are located at different heights along the first frame and wherein the plurality of steps attached to the second frame are located a different heights along the second frame such the plurality of steps on the first frame are staggered relative to the plurality of steps on the second frame.

5. The double-sided step ladder of claim 1, wherein the first height is about 6 inches.

6. The double-sided step ladder of claim 5, wherein the second height is about 12 inches.

7. The double sided step ladder of claim 1, further comprising a support plate.
